(19) United States
(12) Patent Application Publication
(10) Pub. No.: US 2008/0189315 A1
(43) Pub. Date: Aug. 7, 2008

(54) Method and server system for creating sensor data record

(75) Inventors: Wen-Hsin Shih, Taipei (TW); Min-Tsung Huang, Taipei (TW)

Correspondence Address: BACON & THOMAS, PLLC, 625 SLATERS LANE, FOURTH FLOOR, ALEXANDRIA, VA, 22314, US

(73) Assignee: INVENTEC CORPORATION, Taipei (TW)

(21) Appl. No.: 11/702,202

(22) Filed: Feb. 5, 2007

(51) Int. Cl. G06F 17/30

(52) U.S. Cl. 707/102; 707/E17.055

(57) ABSTRACT

The present invention discloses a method and a server system for creating a sensor data record, wherein the server system has a first product code stored therein in advance. After the server system reads the first product code, the server system is able to read all monitoring information stored in a second storage unit and required by the server system through a link list stored in a first storage unit of the server system and copy the monitoring information to a third storage unit, so as to complete creating a sensor data record.

### FIELD OF THE INVENTION

The invention relates to server systems, and more particularly to a server system for creating sensor data record and method thereof.

### BACKGROUND OF THE INVENTION

The Intelligent Platform Management Interface (abbreviated as IPMI hereafter) uses several standard interfaces (such as I²C/IPMB interface, Serial/Modem interface, and LAN interface) controlled by the baseboard management controller (abbreviated as BMC hereafter) to connect to the sensors of the components that require monitoring (such as CPU, voltage, and the speed of fan), so that data from all sensors can be collected. If the BMC detects there is any emergency events in the monitored components from the information provided in sensor data, the BMC would then correct the server system, so that the system could continue to provide services, or pause the provision of services to prevent more severe errors from occurring.

Moreover, the IPMI also includes a sensor data recorder, which is a single and non-volatile storage unit; it is independent of CPU, BIOS, operation system, and system management software, and the sensor data recorder is under the management of BMC. The sensor data recorder holds a sensor data record, which includes monitoring information such as the monitoring threshold and the data about occurred events from each of the sensors. The BMC checks every sensor in turns according to the sensor data record, so as to obtain data from all of the sensors and determine whether the sensor data exceeds the monitoring threshold value or not. If the sensor data exceeds the monitoring threshold value, the BMC sends data about the occurred events to a remote terminal (such as the workstation used by the system administrator), so that the system administrator at the remote terminal can be made aware of the problem and work on it.

For example, a server system can be set to monitor the temperature of its CPU in the sensor data record, and such temperature is usually slightly lower than the temperature that may cause the CPU to overheat and shutdown; when the temperature of the CPU reaches such temperature, the BMC will send the data about the occurred event to the remote terminal; if the temperature of the CPU exceeds such temperature, the BMC will increase the speed of the fan in an attempt to cool down the CPU. If the temperature of the CPU remains high and even exceeds the temperature that represents emergency, the BMC would cut off power supply of the system, and record the events, and subsequently send a warning to the remote terminal via the LAN interface or the serial modem.

In addition, it is common practice to install motherboards of the same series in server systems with different specifications, and only a few components become varied in different server systems, such as backplanes, chassis, fans in the case, CPU, heatsinks, and fans. Therefore, the manufacturers of server systems term the server systems with different specifications and motherboards of the same series as Multi-Stock Keeping Unit (abbreviated as Multi-SKU hereafter); while each of the server systems with different specifications under Multi-SKU are called the Stock Keeping Unit (abbreviated as SKU hereafter).

Although each SKU corresponds to a number of different components, the monitored components of the majority of SKUs only vary slightly. However, for the purpose of addressing such variation, the manufacturer of the current server systems still edit and match the sensor data record of each of the SKUs, and then write the matched sensor data record into the sensor data recorder of each of the SKUs. But problems like writing the sensor data record of a SKU with specification B into the sensor data recorder of a SKU with specification A due to errors often occur, which in turn leads to inconvenience and difficulties to the manufacturers during the production of server systems.

### SUMMARY OF THE INVENTION

In light of the disadvantages of the server systems of prior art, a method and a server system for creating sensor data record have been disclosed in this invention.

A major objective of the invention is to propose a method for creating sensor data record, which is applied in a server system. After the server system reads a first product code, it then compares the first product code with a link list stored in a first storage unit, so that it can find a second product code that matches the first product code from the link list, and then it reads the data of storage location corresponding to the second product code from the link list. Subsequently, the server system reads multiple storage locations by using the data of storage location, and then obtains each of the monitoring information it needs before copying such monitoring information to a third storage unit, thereby creating a sensor data record from such monitoring information. Accordingly, the problem of writing erroneous data into sensor data recorder observed in conventional server systems can be prevented.

Another objective of the invention is to propose a server system for creating sensor data record, which comprises a first storage unit, a second storage unit, a BMC (Baseboard Management Controller), and a third storage unit. The first storage unit has a link list stored therein; the second storage unit has a plurality of monitoring information stored therein. From the link list of the first storage unit, the BMC finds a second product code that match a first product code stored in the server system in advance, as well as the data of storage location corresponding to the second product code from the link list, so as to read each of the storage location by using the data of storage location and obtain the monitoring information required by the server system. The third storage unit is used to store the monitoring information from the BMC that is needed to create sensor data record. Consequently, the problem of writing erroneous data into sensor data recorder can be solved.

### BRIEF DESCRIPTION OF DRAWINGS

The foregoing aspects, as well as many of the attendant advantages and features of this invention will become more apparent by reference to the following detailed description, when taken in conjunction with the accompanying drawings, wherein:

FIG. 1 shows a server system according to the invention.

FIG. 2 is a flow chart showing a method according to the invention.

FIG. 3 shows a link list according to the invention.

FIG. 4 shows the monitoring information stored in the second storage unit according to the invention.

### DETAILED DESCRIPTION OF PREFERRED EMBODIMENTS

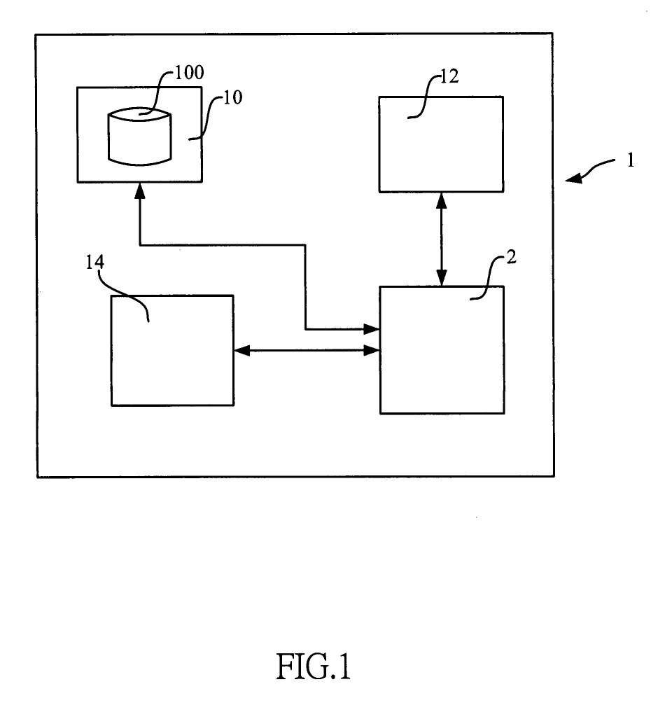

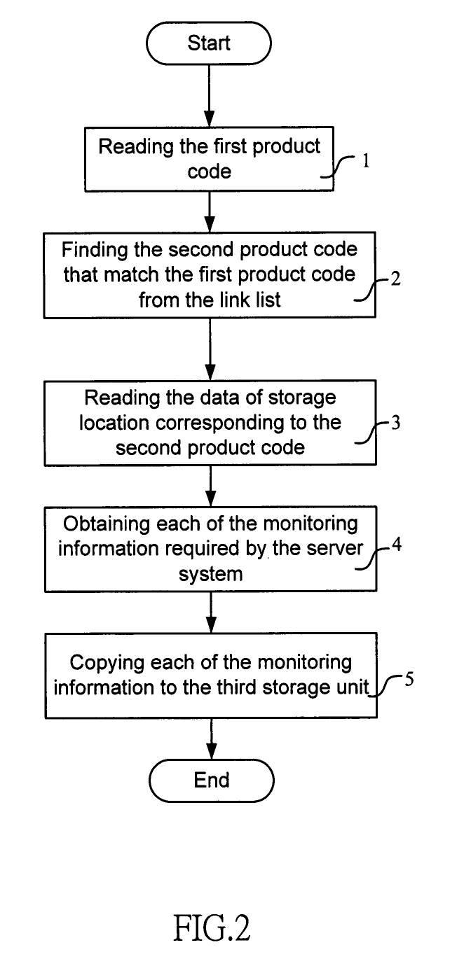

Referring to FIG. 1, the invention discloses a method for creating sensor data record, which is applied in a server system 1. As indicated in FIG. 1 and FIG. 2, when the server system 1 is activated, a BMC 2 creates sensor data record according to the following steps:

(1) reading a first product code stored in the server system 1 in advance; in a preferred embodiment of the invention, the first product code can be a SKU ID;

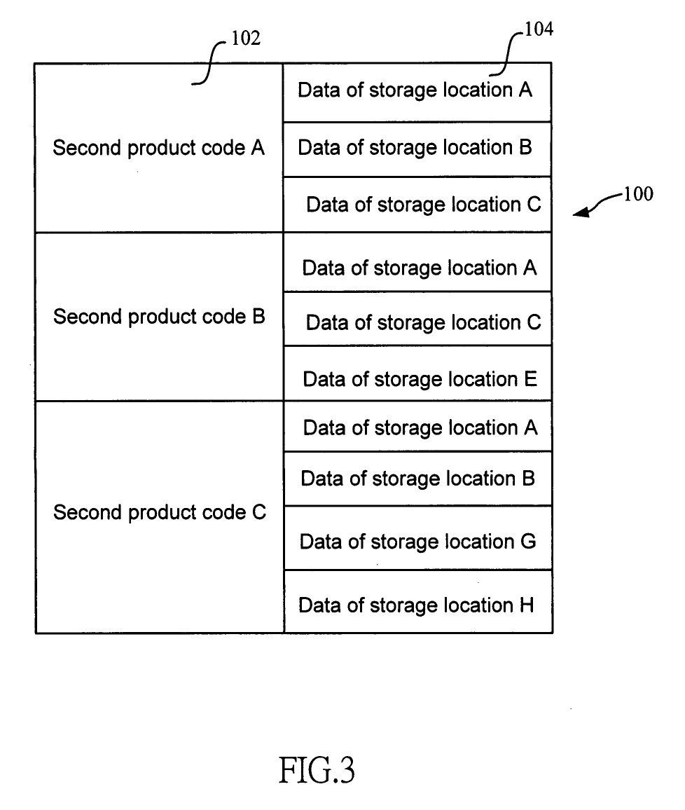

(2) comparing the first product code with a link list 100 stored in a first storage unit 10 (as shown in FIG. 3), so as to find a second product code 102 that matches the first product code from the link list 100; in the preferred embodiment, the link list 100 includes a plurality of second product codes 102 and corresponding data of storage location 104, in which each of the second product codes 102 corresponds to a single first product code in the server system 1 with different specification, and the data of storage location 104, which the second product code 102 corresponds to, includes the storage location of different entries of monitoring information that is stored in the second storage unit 12;

(3) reading the data of storage location 104, which the second product code 102 corresponds to, from the link list 100;

(4) obtaining the monitoring information required by the server system 1 from each of the storage location from the second storage unit 12, in accordance with the plurality of storage locations included in the data of storage location 104; and

(5) copying the monitoring information to a third storage unit 14 for creating sensor data records, and thus completing the overall steps.

From the description above, it can be seen that the BMC 2 does not work in the same way the sensor data recorder of prior art does. The BMC 2 finds the monitoring information that matches the server system 1 from the link list 100 and from the second storage unit 12, and then creates the sensor data record. Therefore, the occurrence of errors, which resulted from a sensor data recorder of a server system 1 with specification A writing data into a sensor data recorder of a server system 1 with specification B, can be prevented.

Referring to FIG. 1, the invention also discloses a server system for creating sensor data record, in which a server system 1 comprises a first storage unit 10 that has a link list 100 stored therein. The link list 100 includes a plurality of second product codes 102 and a plurality of data of storage location 104, which allows the first product codes from a server system 1 with different specification to be matched to its corresponding second product codes 102 in the link list 100. Each of second product code 102 corresponds to a data of storage location 104, respectively, and each of data of storage location 104 includes the storage location of a plurality of monitoring information that is stored in the second storage unit 12. Moreover, the aforesaid monitoring information includes the monitoring threshold and data about the occurred events from all of the sensors in the server system 1 with different specifications.

Furthermore, the server system 1 also comprises a third storage unit 14 and a BMC 2, in which the BMC 2 is electrically connected to the first, the second, and the third storage units 10, 12, and 14. The BMC 2 can read the first product code from the server system 1, and use it to find a second product code 102 that matches the first product code from the link list 100, it subsequently reads the data of storage location 104 that is corresponding to the second product code 102, and then obtains the monitoring information required by the server system 1 from the storage location of the second storage unit 12, this is followed by copying the monitoring information required by the server system 1 to the third storage unit 14, thereby completing the creation of sensor data record.

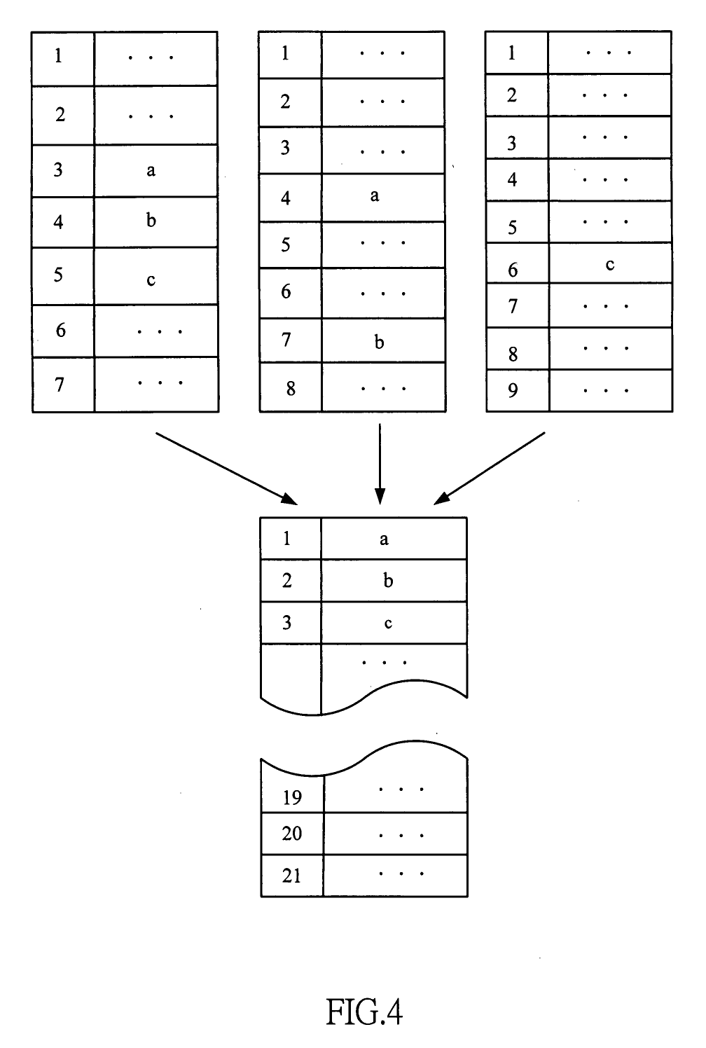

For example, if there are three server systems called A, B, and C, and each has different specifications, and system A needs seven entries of monitoring information, system B needs eight entries of monitoring information, and system C requires nine entries of monitoring information. After comparison, it was found that system A and system B has identical entries of monitoring information called a and b, while system A and system C has an identical entry of monitoring information called c, then it only needs to store the three entries of identical monitoring information a, b, and c, and eighteen different entries of monitoring information in the second storage unit 12 (as shown in FIG. 4). In other words, it only needs to store a total of twenty-one entries of monitoring information in the second storage unit 12 instead of twenty-four, which significantly preserves the storage capacity in the second storage unit 12. As a result, as long as the second product code 102 of the link list 100 matches the first product code of the server systems A, B, and C, and each of the second product code 102 corresponds to the required monitoring information, the sensor data record can be successfully created, thereby solving the problem of storing erroneous sensor data records in the server system as observed in traditional server systems.

While the invention herein disclosed has been described by means of specific embodiments, numerous modifications and variations could be made thereto by those skilled in the art without departing from the scope and spirit of the invention set forth in the claims.

What is claimed is:

1. A method for creating sensor data record being applicable to a server system, when said server system is activated, comprising the following steps for creating sensor data record:
reading a first product code stored in said server system in advance;
comparing said first product code with a link list to find a second product code that matches said first product code from said link list;
reading data of storage location corresponding to said second product code from said link list;
obtaining a plurality of monitoring information corresponding to said data of storage location from a second storage unit; and
copying said plurality of monitoring information to a third storage unit for creating sensor data records.

2. The method of claim 1, wherein said first product code is a stock keeping unit ID.

3. The method of claim 1, wherein said data of storage location includes storage location of the plurality of monitoring information stored in the second storage unit.

4. A server system for creating sensor data record, which has a first product code stored therein in advance, comprising:
a first storage unit having a link list stored therein, said link list includes a plurality of second product codes and a plurality of data of storage location, each of said second product code corresponds to a single data of storage location;
a second storage unit having a plurality of monitoring information stored therein for being selected and used by server systems with different specifications;
a baseboard management controller (BMC) electrically connected to said first storage unit and said second storage unit, said BMC reads said first product code and finds one of said second product codes that matches said first product code from said link list, and subsequently reads said data of storage location corresponding to said second product code that matches said first product code, so as to obtain monitoring information required by said server system; and
a third storage unit electrically connected to said BMC for storing said monitoring information required by said server system.

5. The server system of claim 4, wherein said data of storage location includes at least one storage location of said monitoring information.

6. The server system of claim 4, wherein said data of storage location includes the storage locations of said monitoring information required by said server system.
